(19) United States
(12) Patent Application Publication
(10) Pub. No.: US 2022/0074623 A1
(43) Pub. Date: Mar. 10, 2022

(54) CUSTOM CONNECTOR KIT WITH A CONNECTOR DEVICE FOR CONNECTING TWO FLEXIBLE DUCTS TOGETHER, AND METHOD OF USE THEREOF

(71) Applicant: Gary A. HAMMOND, Tega Cay, SC (US)

(72) Inventor: Gary A. HAMMOND, Tega Cay, SC (US)

(21) Appl. No.: 17/467,209

(22) Filed: Sep. 4, 2021

Related U.S. Application Data
(60) Provisional application No. 63/081,870, filed on Sep. 22, 2020.
(60) Provisional application No. 63/074,522, filed on Sep. 4, 2020.

(51) Int. Cl. F24F 13/02; F16L 21/00

(52) U.S. Cl. CPC F24F 13/0209; F24F 13/0218; F16L 21/005

(57) ABSTRACT

A custom connector kit for connecting 2 flexible ducts together includes a connector device. The connector device is configured to connect two flexible ducts together. The connector device includes a first male connection end and a second male connection end. The first male connection end is at a first distal end of the connector device. The first male connection end is configured to be connected to a first flexible duct. The first male connection end includes a first diameter sized to fit securely inside of the first flexible duct. The second male connection end is at a second distal end of the connector device. The second male connection end is configured to be connected to a second flexible duct. The second male connection end includes a second diameter sized to fit securely inside of the second flexible duct.

### CROSS-REFERENCE To RELATED APPLICATIONS

This application claims priority benefit to U.S. Provisional Patent Application No. 63/074,522, filed on Sep. 4, 2020, entitled “Custom Connector for Connecting 2 Flexible Ducts Together” and U.S. Provisional Patent Application No. 63/081,870, filed on Sep. 22, 2020, entitled “Flex Duct Custom Connector Kit”, which are incorporated by reference in their entirety.

### FIELD OF THE DISCLOSURE

The present disclosure is directed to ductwork, and more specifically to flexible ductwork. Namely, the present disclosure is directed toward a custom connector kit with a connector device configured for connecting 2 flexible ducts together, and a method of use thereof.

### BACKGROUND

Generally speaking, ducts are conduits or passages used in heating, ventilation, and air conditioning (HVAC) to deliver and remove air. The needed airflows include, for example, supply air, return air, and exhaust air. Ducts commonly also deliver ventilation air as part of the supply air. As such, air ducts are one method of ensuring acceptable indoor air quality as well as thermal comfort. A duct system is also called ductwork. Planning (laying out), sizing, optimizing, detailing, and finding the pressure losses through a duct system is called duct design.

Flexible ducts (also known as flex) are typically made of flexible plastic over a metal wire coil to shape a tube. They have a variety of configurations. In the United States, the insulation is usually glass wool, but other markets such as Australia, use both polyester fiber and glass wool for thermal insulation. A protective layer surrounds the insulation, and is usually composed of polyethylene or metalized PET. It is commonly sold as boxes containing 25′ of duct compressed into a 5′ length. It is available in diameters ranging from as small as 4″ to as big as 18″, but the most commonly used are sizes ranging from 6″ to 16″.

Flexible duct is very convenient for attaching supply air outlets to the rigid ductwork. It is commonly attached with long zip ties or metal band claps. However, the pressure loss is higher than for most other types of ducts. As such, designers and installers attempt to keep their installed lengths (runs) short, e.g., less than 15 feet or so, and try to minimize turns. Kinks in flexible ducting must be avoided.

One problem that has been discovered with flexible ducts is, because of the material they are made from, to provide their flexible nature, they can easily be damaged. This damage may include rips and/or tears in the inner liner and/or the outer insulation layer. Because there is no known means or method to connect a flexible duct with another flexible duct, once a flexible duct is damaged, typically the whole duct line has to be replaced. This is obviously costly and can be very time consuming. As such, there is clearly a need to provide a means and/or method of connecting flexible ducts together to aid in repairing damaged sections of flexible ductwork.

The instant disclosure may be designed to address at least certain aspects of the problems or needs discussed above by providing a custom connector kit and connector device for connecting two flexible ducts, and a method of use thereof.

### SUMMARY

The present disclosure may solve the above-mentioned problems of connecting flexible ducts together by providing the disclosed custom connector kit and connector device for connecting two flexible ducts, and a method of use thereof. Accordingly, in one aspect, the present disclosure embraces a custom connector kit for connecting two flexible ducts together. The custom connector kit may generally include a connector device. The connector device may be configured to connect the two flexible ducts together. The connector device may include a first male connection end and a second male connection end. The first male connection end may be at a first distal end of the connector device. The first male connection end may be configured to be connected to a first flexible duct. The first male connection end may include a first diameter sized to fit securely inside of the first flexible duct. The second male connection end may be at a second distal end of the connector device. The second male connection end may be configured to be connected to a second flexible duct. The second male connection end may include a second diameter sized to fit securely inside of the second flexible duct.

In select embodiments of the disclosed custom connector kit for connecting two flexible ducts together, the connector device may further include a first taping surface with a first rounded lip and a second taping surface with a second rounded lip. The first rounded lip may be around the first male connection end at a first lip distance from the first distal end of the connector device. The first rounded lip may be configured for securing the first inner liner of the first flexible duct to the first male connection end. The first taping surface may be around the connector device. The first taping surface may be configured for taping a first inner liner of the first flexible duct to the first male connection end. The first taping surface may be adjacent to the first rounded lip. The second rounded lip may be around the second male connection end at a second lip distance from the second distal end of the connector device. The second rounded lip may be configured for securing the second inner liner of the second flexible duct to the second male connection end. The second taping surface may be around the connector device. The second taping surface may be configured for taping a second inner liner of the second flexible duct to the second male connection end. The second taping surface may be adjacent to the second rounded lip.

One feature of the disclosed custom connector kit for connecting two flexible ducts together may be that the connector device may be configured for connecting the first flexible duct to the second flexible duct by: taping the first inner liner of the first flexible duct to the first taping surface at the first male connection end; securing the first inner liner of the first flexible duct to the first male connection end; taping the second inner liner of the second flexible duct to the second taping surface at the second male connection end; securing the second inner liner of the second flexible duct to the second male connection end; and taping the first outer insulation of the first flexible duct to the second outer insulation of the second flexible duct.

Another feature of the disclosed custom connector kit for connecting two flexible ducts together may be that the connector device may include an adjustable diameter. With the adjustable diameter of the connector device, the custom connector kit may be configured with the ability to custom fit multiple size ducts together. In select embodiments, the connector device with an adjustable diameter may include a sheet of material with a rounded length and a width. The sheet of material may be configured to bend along the rounded length to create a circular pipe shape of the connector device with the adjustable diameter. In select embodiments, the sheet of material may include a plurality of first holes approximate a fixed end of the rounded length. A first set of a plurality of second holes may be approximate an adjustable end of the rounded length. In addition, at least one second set of a plurality of the second holes at a set distance from the adjustable end of the rounded length may be included. Wherein, the adjustable diameter of the connector device created by the sheet of material is adjustable between a large diameter and at least one smaller diameter. The large diameter may be created by connecting the first holes at the fixed end of the rounded length with the first set of the second holes at the adjustable end of the rounded length, like via screws. The at least one smaller diameter may be created by connecting the first holes at the fixed end of the rounded length with one of the at least one second set of the second holes at the set distance from the adjustable end of the rounded length.

In select embodiments of the disclosed custom connector kit for connecting two flexible ducts together, the adjustable diameter of the connector device may be configured to adjust for connecting sizes of 6 inches through 8 inches of flexible ducts. This 6 inches through 8 inches embodiment may include being configured for connecting 6-inch flexible ducts, 7-inch flexible ducts, and 8-inch flexible ducts.

In select embodiments of the disclosed custom connector kit for connecting two flexible ducts together, the adjustable diameter of the connector device may be configured to adjust for connecting sizes of 10 inches through 16 inches of flexible ducts. This 10 inches through 16 inches embodiment may include being configured for connecting 10-inch flexible ducts, 12-inch flexible ducts, 14-inch flexible ducts, and 16-inch flexible ducts.

In select embodiments of the disclosed custom connector kit for connecting two flexible ducts together, at least two connector devices may be included. A first connector device may be included wherein the adjustable diameter of the connector device is configured to adjust for connecting sizes of 6 inches through 8 inches of flexible ducts, including 6-inch flexible ducts, 7-inch flexible ducts, and 8-inch flexible ducts. A second connector device may be included wherein the adjustable diameter of the connector device is configured to adjust for connecting sizes of 10 inches through 16 inches of flexible ducts, including 10-inch flexible ducts, 12-inch flexible ducts, 14-inch flexible ducts, and 16-inch flexible ducts.

Another feature of the disclosed custom connector kit for connecting two flexible ducts together may be that the sheet of material can further including markings. The markings included may be for the first set of the second holes and each of the second set of the second holes. In select embodiments, the markings for the first set of the second holes may include a number and a diameter line. The number may indicate the adjustable diameter of the connector device at the corresponding first set of the second holes. The diameter line may indicate a fixed end location for creating a corresponding adjustable diameter. In other select embodiments, the markings for each of the second sets of the second holes can include the number, the diameter line, and a cut line. The number may indicate the adjustable diameter of the connector device at the corresponding second set of the second holes. The diameter line may indicate a fixed end location for creating a corresponding adjustable diameter. The cut line may indicate a cutting location for cutting excess material of the sheet of material at the corresponding second set of the second holes. In select embodiments of the custom connector kit for connecting two flexible ducts together, the kit may include at least two connector devices. A first connector device may be included wherein the adjustable diameter of the connector device is configured to adjust for connecting sizes of 6 inches through 8 inches of flexible ducts, including: 6-inch flexible ducts where the markings including the number being a number 6, a diameter line indicating the fixed end location for creating a 6-inch diameter, and the cut line for removing excess material of the sheet not required for the 6-inch diameter; 7-inch flexible ducts where the markings including the number being a number 7, a diameter line indicating the fixed end location for creating a 7-inch diameter, and the cut line for removing excess material of the sheet not required for the 7-inch diameter; and 8-inch flexible ducts where the markings including the number being a number 8, and a diameter line indicating the fixed end location for creating an 8-inch diameter. The second connector device may be included wherein the adjustable diameter of the connector device is configured to adjust for connecting sizes of 10 inches through 16 inches of flexible ducts, including: 10-inch flexible ducts where the markings including the number being a number 10, a diameter line indicating the fixed end location for creating a 10-inch diameter, and the cut line for removing excess material of the sheet not required for the 10-inch diameter; 12-inch flexible ducts where the markings including the number being a number 12, a diameter line indicating the fixed end location for creating a 12-inch diameter, and the cut line for removing excess material of the sheet not required for the 12-inch diameter; 14-inch flexible ducts where the markings including the number being a number 14, a diameter line indicating the fixed end location for creating a 14-inch diameter, and the cut line for removing excess material of the sheet not required for the 14-inch diameter; and 16-inch flexible ducts where the markings including the number being a number 16, a diameter line indicating the fixed end location for creating a 16-inch diameter.

One feature of the disclosed custom connector kit for connecting two flexible ducts together may be that the custom connector kit can be configured with an ability to save space because it is knocked down or not put together.

Another feature of the disclosed custom connector kit for connecting two flexible ducts together may be that it can include necessary materials to custom fit multiple size ducts together. In select embodiments, the necessary materials may include, but are not limited to, a small galvanized pipe connector configured to fit sizes 6 inch through 8 inch; a large galvanized pipe connector configured to fit sizes 10 inch through 16 inch; fifteen feet of foil tape; twelve 36-inch cable ties; ten feet of nylon hanging strap; four 10×½ screws; one 12×12×6 box; four 1-inch roofing nails; four 5/12″¾″ self-tapping metal screws; the like; and/or combinations thereof.

In another aspect, the instant disclosure embraces a connector device for connecting two flexible ducts together. The connector device may include the connector device in any embodiment and/or embodiments of the custom connector kit shown and/or described herein. As such, in general, the connector device may include a first male connection end and a second male connection end. The first male connection end may be at a first distal end of the connector device. The first male connection end may be configured to be connected to a first flexible duct. The first male connection end may include a first diameter sized to fit securely inside of the first flexible duct. The second male connection end may be at a second distal end of the connector device. The second male connection end may be configured to be connected to a second flexible duct. The second male connection end may include a second diameter sized to fit securely inside of the second flexible duct.

In select embodiments of the disclosed connector device, the connector device may further include a first taping surface with a first rounded lip and a second taping surface with a second rounded lip. The first rounded lip may be around the first male connection end at a first lip distance from the first distal end of the connector device. The first rounded lip may be configured for securing the first inner liner of the first flexible duct to the first male connection end. The first taping surface may be around the connector device. The first taping surface may be configured for taping a first inner liner of the first flexible duct to the first male connection end. The first taping surface may be adjacent to the first rounded lip. The second rounded lip may be around the second male connection end at a second lip distance from the second distal end of the connector device. The second rounded lip may be configured for securing the second inner liner of the second flexible duct to the second male connection end. The second taping surface may be around the connector device. The second taping surface may be configured for taping a second inner liner of the second flexible duct to the second male connection end. The second taping surface may be adjacent to the second rounded lip.

One feature of the disclosed connector device for connecting two flexible ducts together may be that the connector device may be configured for connecting the first flexible duct to the second flexible duct by: taping the first inner liner of the first flexible duct to the first taping surface at the first male connection end; securing the first inner liner of the first flexible duct to the first male connection end; taping the second inner liner of the second flexible duct to the second taping surface at the second male connection end; securing the second inner liner of the second flexible duct to the second male connection end; and taping the first outer insulation of the first flexible duct to the second outer insulation of the second flexible duct.

Another feature of the disclosed connector device for connecting two flexible ducts together may be that the connector device may include an adjustable diameter. With the adjustable diameter of the connector device, the connector device may be configured with the ability to custom fit multiple size ducts together. In select embodiments, the connector device with an adjustable diameter may include a sheet of material with a rounded length and a width. The sheet of material may be configured to bend along the rounded length to create a circular pipe shape of the connector device with the adjustable diameter. In select embodiments, the sheet of material may include a plurality of first holes approximate a fixed end of the rounded length. A first set of a plurality of second holes may be approximate an adjustable end of the rounded length. In addition, at least one second set of a plurality of the second holes at a set distance from the adjustable end of the rounded length may be included. Wherein, the adjustable diameter of the connector device created by the sheet of material is adjustable between a large diameter and at least one smaller diameter. The large diameter may be created by connecting the first holes at the fixed end of the rounded length with the first set of the second holes at the adjustable end of the rounded length, like via screws. The at least one smaller diameter may be created by connecting the first holes at the fixed end of the rounded length with one of the at least one second set of the second holes at the set distance from the adjustable end of the rounded length.

In select embodiments of the disclosed connector device for connecting two flexible ducts together, the adjustable diameter of the connector device may be configured to adjust for connecting sizes of 6 inches through 8 inches of flexible ducts. This 6 inches through 8 inches embodiment may include being configured for connecting 6-inch flexible ducts, 7-inch flexible ducts, and 8-inch flexible ducts.

In select embodiments of the disclosed connector device for connecting two flexible ducts together, the adjustable diameter of the connector device may be configured to adjust for connecting sizes of 10 inches through 16 inches of flexible ducts. This 10 inches through 16 inches embodiment may include being configured for connecting 10-inch flexible ducts, 12-inch flexible ducts, 14-inch flexible ducts, and 16-inch flexible ducts.

In select embodiments of the disclosed connector device for connecting two flexible ducts together, at least two connector devices may be included. A first connector device may be included wherein the adjustable diameter of the connector device is configured to adjust for connecting sizes of 6 inches through 8 inches of flexible ducts, including 6-inch flexible ducts, 7-inch flexible ducts, and 8-inch flexible ducts. A second connector device may be included wherein the adjustable diameter of the connector device is configured to adjust for connecting sizes of 10 inches through 16 inches of flexible ducts, including 10-inch flexible ducts, 12-inch flexible ducts, 14-inch flexible ducts, and 16-inch flexible ducts.

Another feature of the disclosed connector device for connecting two flexible ducts together may be that the sheet of material can further including markings. The markings included may be for the first set of the second holes and each of the second set of the second holes. In select embodiments, the markings for the first set of the second holes may include a number and a diameter line. The number may indicate the adjustable diameter of the connector device at the corresponding first set of the second holes. The diameter line may indicate a fixed end location for creating a corresponding adjustable diameter. In other select embodiments, the markings for each of the second sets of the second holes can include the number, the diameter line, and a cut line. The number may indicate the adjustable diameter of the connector device at the corresponding second set of the second holes. The diameter line may indicate a fixed end location for creating a corresponding adjustable diameter. The cut line may indicate a cutting location for cutting excess material of the sheet of material at the corresponding second set of the second holes. In select embodiments of the connector device, the adjustable diameter of the connector device may be configured to adjust for connecting sizes of 6 inches through 8 inches of flexible ducts, including: 6-inch flexible ducts where the markings including the number being a number 6, a diameter line indicating the fixed end location for creating a 6-inch diameter, and the cut line for removing excess material of the sheet not required for the 6-inch diameter; 7-inch flexible ducts where the markings including the number being a number 7, a diameter line indicating the fixed end location for creating a 7-inch diameter, and the cut line for removing excess material of the sheet not required for the 7-inch diameter; and 8-inch flexible ducts where the markings including the number being a number 8, and a diameter line indicating the fixed end location for creating an 8-inch diameter. In other select embodiments of the connector device, the adjustable diameter of the connector device may be configured to adjust for connecting sizes of 10 inches through 16 inches of flexible ducts, including: 10-inch flexible ducts where the markings including the number being a number 10, a diameter line indicating the fixed end location for creating a 10-inch diameter, and the cut line for removing excess material of the sheet not required for the 10-inch diameter; 12-inch flexible ducts where the markings including the number being a number 12, a diameter line indicating the fixed end location for creating a 12-inch diameter, and the cut line for removing excess material of the sheet not required for the 12-inch diameter; 14-inch flexible ducts where the markings including the number being a number 14, a diameter line indicating the fixed end location for creating a 14-inch diameter, and the cut line for removing excess material of the sheet not required for the 14-inch diameter; and 16-inch flexible ducts where the markings including the number being a number 16, a diameter line indicating the fixed end location for creating a 16-inch diameter.

In another aspect, the instant disclosure embraces a method for connecting two flexible ducts together. The disclosed method for connecting two flexible ducts together may utilize the disclosed custom connector kit and/or connecting pipe in any embodiment and/or embodiments shown and/or described herein. As such, in general the disclosed method for connecting two flexible ducts together may include providing the disclosed connector device configured to connect two flexible ducts together, where the connector device generally includes a first male connection end and a second male connection end. The first male connection end may be at a first distal end of the connector device. The first male connection end may be configured to be connected to a first flexible duct. The first male connection end may include a first diameter sized to fit securely inside of the first flexible duct. The second male connection end may be at a second distal end of the connector device. The second male connection end may be configured to be connected to a second flexible duct. The second male connection end may include a second diameter sized to fit securely inside of the second flexible duct. With the provided connector device, the method for connecting two flexible ducts together may further include the step of connecting the two flexible ducts together via the provided connector device.

In select embodiments of the disclosed method for connecting two flexible ducts together, the connector device may further include a first taping surface with a first rounded lip and a second taping surface with a second rounded lip. The first rounded lip may be around the first male connection end at a first lip distance from the first distal end of the connector device. The first rounded lip may be configured for securing the first inner liner of the first flexible duct to the first male connection end. The first taping surface may be around the connector device. The first taping surface may be configured for taping a first inner liner of the first flexible duct to the first male connection end. The first taping surface may be adjacent to the first rounded lip. The second rounded lip may be around the second male connection end at a second lip distance from the second distal end of the connector device. The second rounded lip may be configured for securing the second inner liner of the second flexible duct to the second male connection end. The second taping surface may be around the connector device. The second taping surface may be configured for taping a second inner liner of the second flexible duct to the second male connection end. The second taping surface may be adjacent to the second rounded lip. Wherein, the method for connecting two flexible ducts together further including: taping the first inner liner of the first flexible duct to the first taping surface at the first male connection end with foil tape; securing the first inner liner of the first flexible duct to the first male connection end with cable ties; taping the second inner liner of the second flexible duct to the second taping surface at the second male connection end with the foil tape; securing the second inner liner of the second flexible duct to the second male connection end with the cable ties; and taping the first outer insulation of the first flexible duct to the second outer insulation of the second flexible duct with the foil tape.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a top front perspective view of a connector device disassembled for connecting 2 flexible ducts together according to select embodiments of the instant disclosure configured for connecting sizes 6 inches through 8 inches of flexible ducts together;

FIG. 2 is a top side perspective view of the connector device from FIG. 1 showing the locations to connect and cut for connecting size 6-inch flexible ducts together, size 7-inch flexible ducts together, and size 8-inch flexible ducts together;

FIG. 3 is a top front perspective view of a connector device disassembled for connecting 2 flexible ducts together according to select embodiments of the instant disclosure configured for connecting sizes 10 inches through 16 inches of flexible ducts together;

FIG. 4 is a top side perspective view of the connector device disassembled from FIG. 3 showing the locations to connect and cut for connecting size 12-inch flexible ducts together, size 14-inch flexible ducts together, and size 16-inch flexible ducts together;

FIG. 5 is a top side perspective view of the connector device from FIG. 3 showing the locations to connect and cut for connecting size 12-inch flexible ducts together, and size 14-inch flexible ducts together;

FIG. 6 is a top side perspective view of the connector device disassembled from FIG. 3 showing the sheet of material cut at the location for connecting size 10-inch flexible ducts together;

FIG. 7 is a top view of a custom connector kit for connecting 2 flexible ducts together according to select embodiments of the instant disclosure packaged in a box;

FIG. 8 is a top view of the screws, roofing nails, and self-tapping metal screws according to select embodiments of the instant disclosure from the custom connector kit of FIG. 7;

FIG. 9 is a top perspective view of the foil tape, cable ties, and hanging strap according to select embodiments of the instant disclosure from the custom connector kit of FIG. 7;

FIG. 10A is a schematic side view of the custom connector kit according to select embodiments of the instant disclosure showing the first inner liner of the first flexible duct being taped to the first male connection end of the connector device via the foil tape;

FIG. 10B is a schematic side view of the custom connector kit of FIG. 10A showing the first inner liner of the first flexible duct being secured to the first male connection end of the connector device via the cable ties;

FIG. 10C is a schematic side view of the custom connector kit of FIG. 10A showing the second inner liner of the second flexible duct being taped to the second male connection end of the connector device via the foil tape;

FIG. 10D is a schematic side view of the custom connector kit of FIG. 10A showing the second inner liner of the second flexible duct being secured to the second male connection end of the connector device via the cable ties;

FIG. 10E is a schematic side view of the custom connector kit of FIG. 10A showing the first outer insulation layer of the first flexible duct being connected to the second outer insulation layer of the second flexible duct via the foil tape;

FIG. 10F is a schematic side view of the custom connector kit of FIG. 10A showing the connector device connected between the first flexible duct and the second flexible duct and the connector device being hung or supported via the hanging strap and screws; and

FIG. 11 is a flow chart of the method of connecting two flexible ducts according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

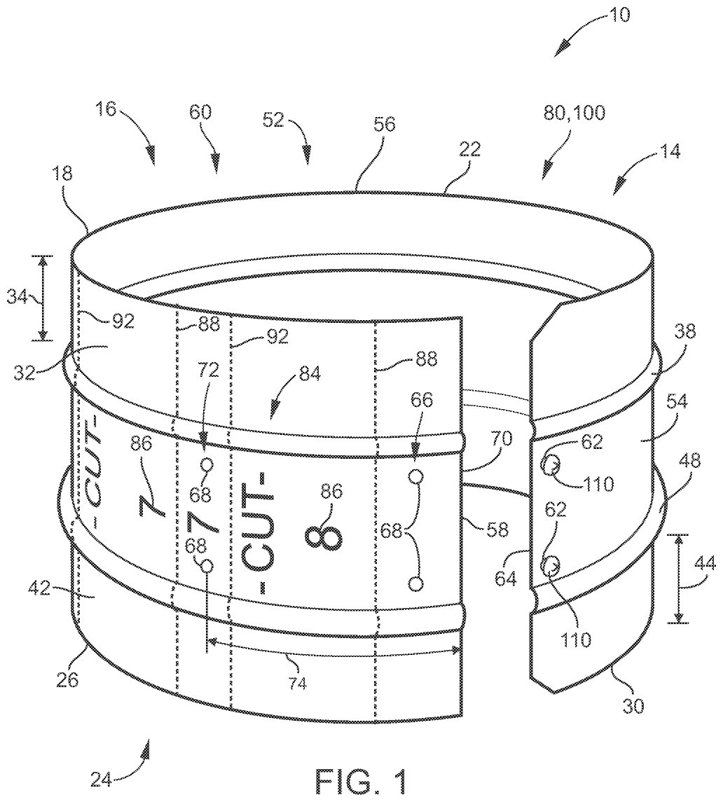

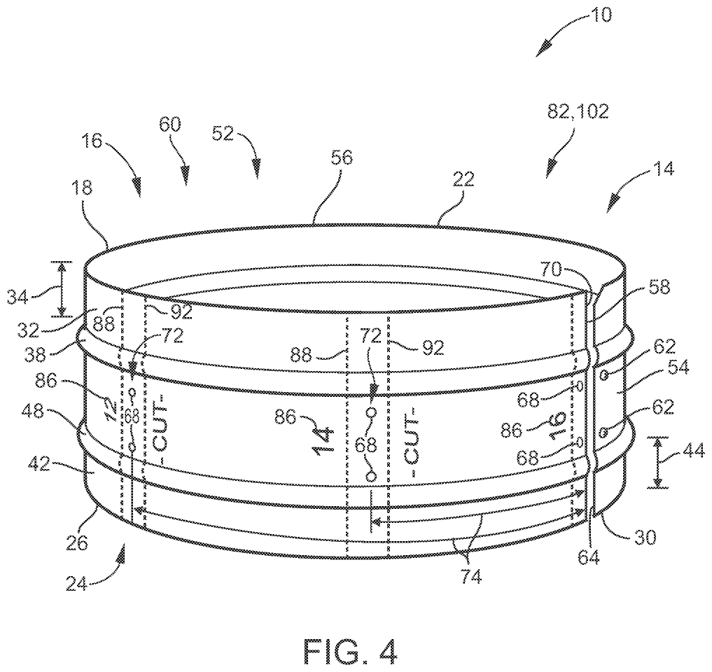

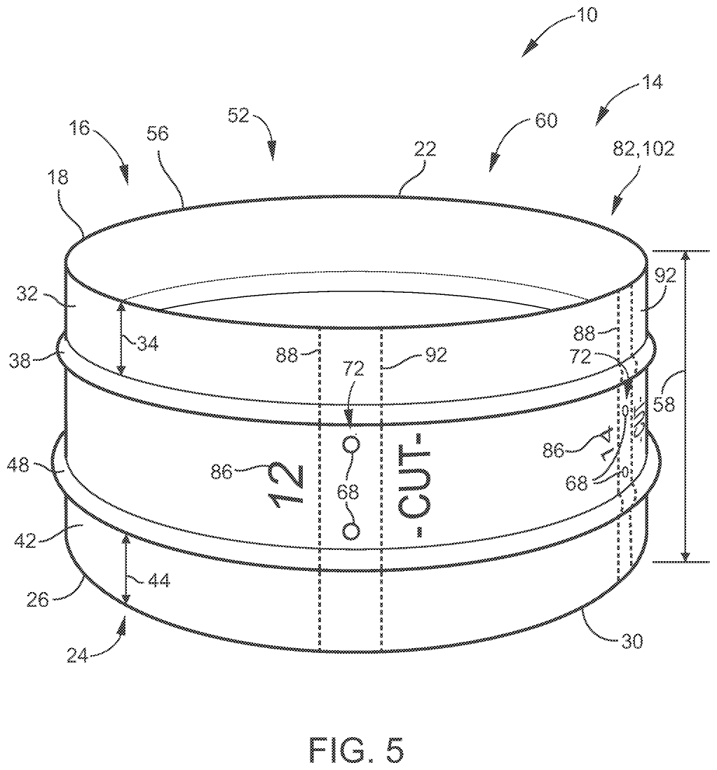

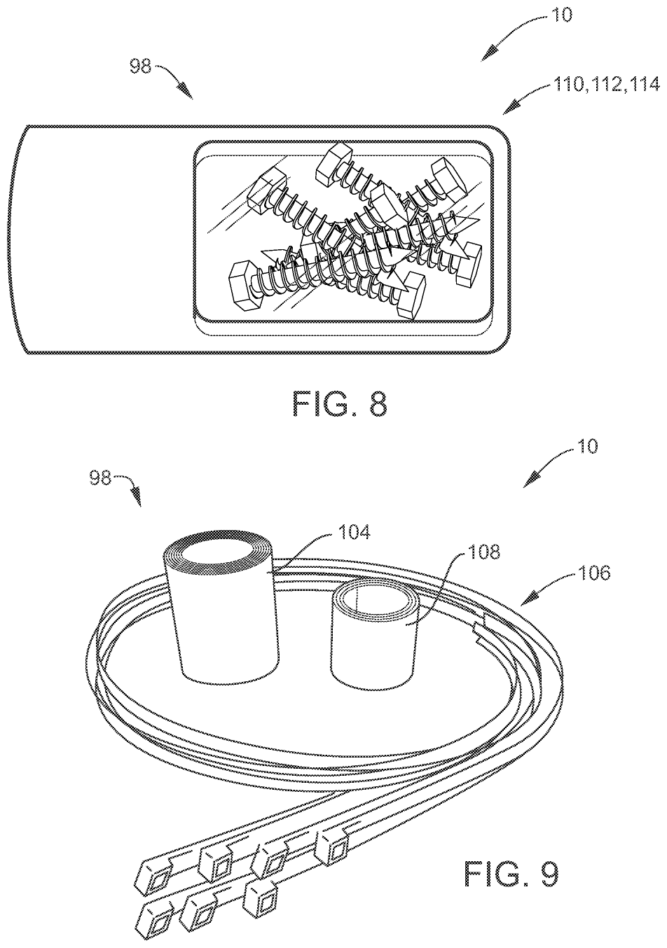

Referring now to FIGS. 1-11, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

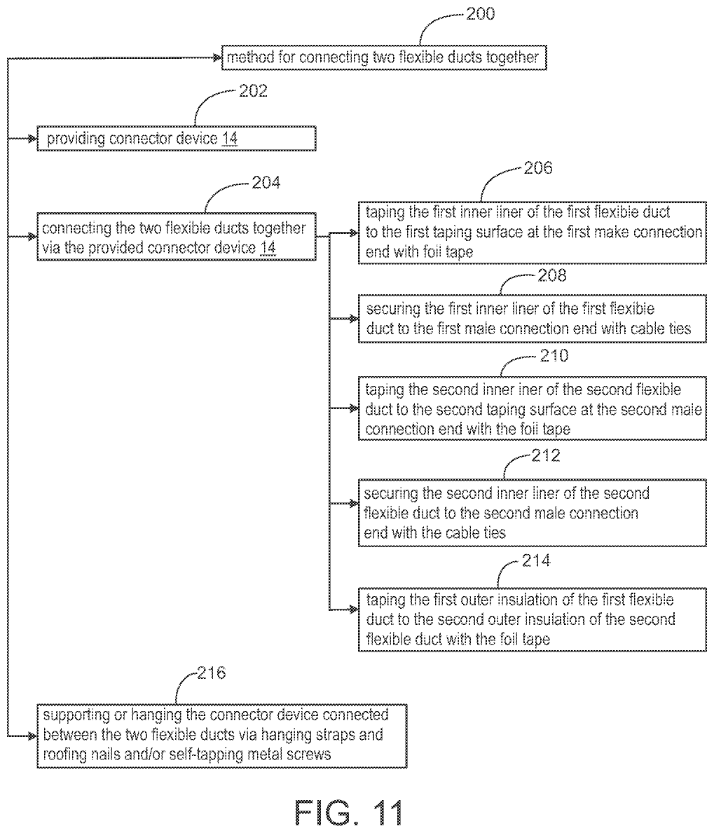

Referring to FIGS. 1-11, the present disclosure may solve the aforementioned limitations of the currently available ducts and ductworks, by providing custom connector kit 10 (see FIGS. 1-10) with connector device 14 (see FIGS. 1-7 and 10) for connecting two flexible ducts 12, and method 200 of use thereof (see FIG. 11). Accordingly, in one aspect, the present disclosure embraces custom connector kit 10 for connecting two flexible ducts 12 together. Custom connector kit 10 may generally include connector device 14. Connector device 14 may be configured to connect two flexible ducts 12 together. Connector device 14 may include first male connection end 16 and second male connection end 24. First male connection end 16 may be at first distal end 18 of connector device 14. First male connection end 16 may be configured to be connected to first flexible duct 20. First male connection end 16 may include first diameter 22 sized to fit securely inside of first flexible duct 20. Second male connection end 24 may be at second distal end 26 of connector device 14. Second male connection end 24 may be configured to be connected to second flexible duct 28. Second male connection end 24 may include second diameter 30 sized to fit securely inside of second flexible duct 28.

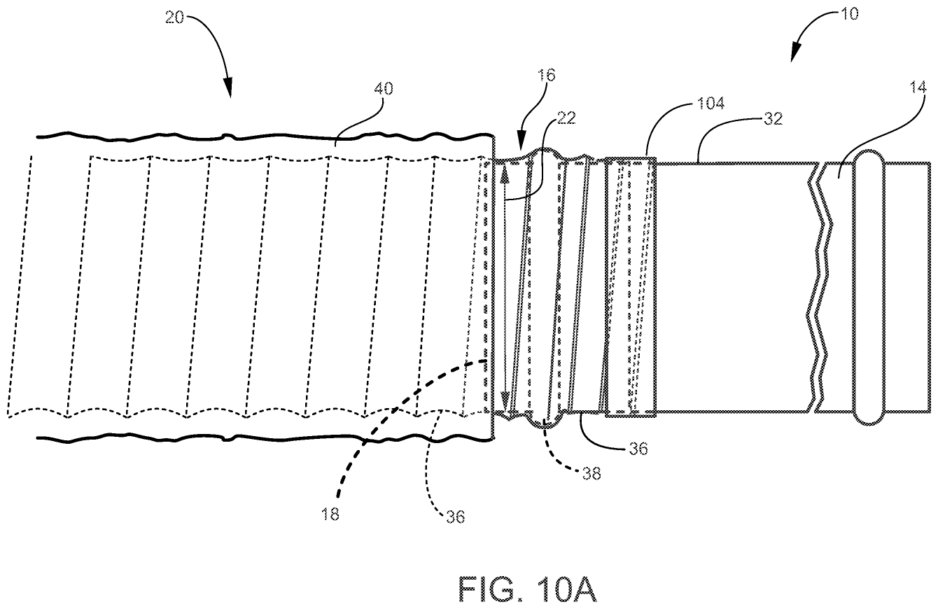

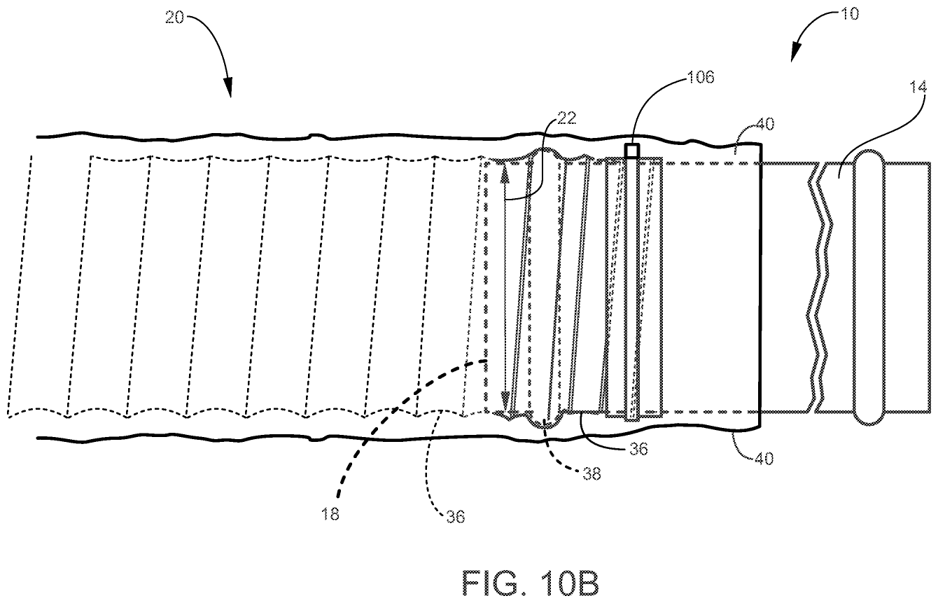

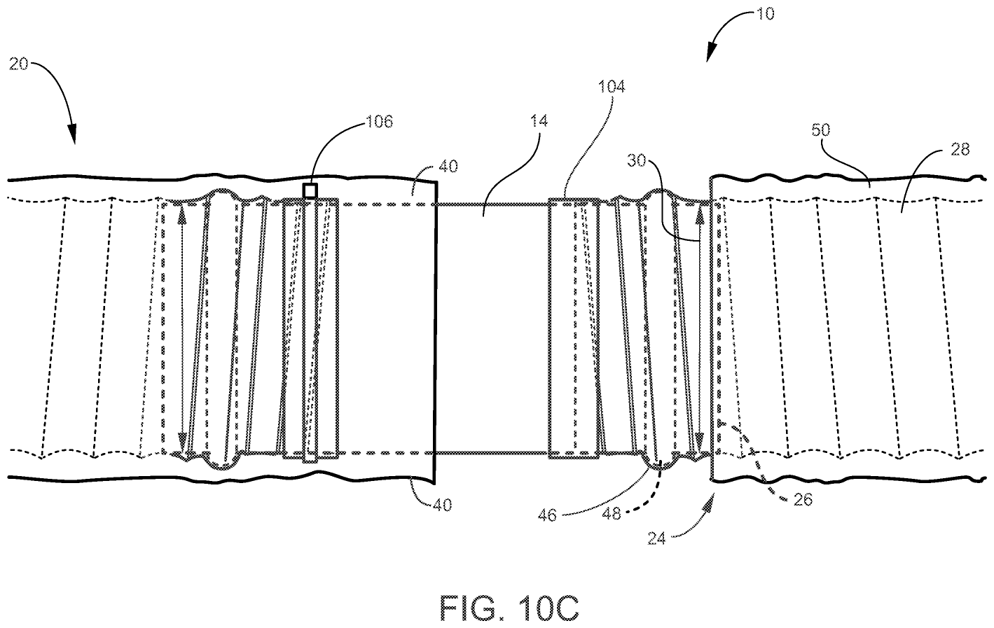

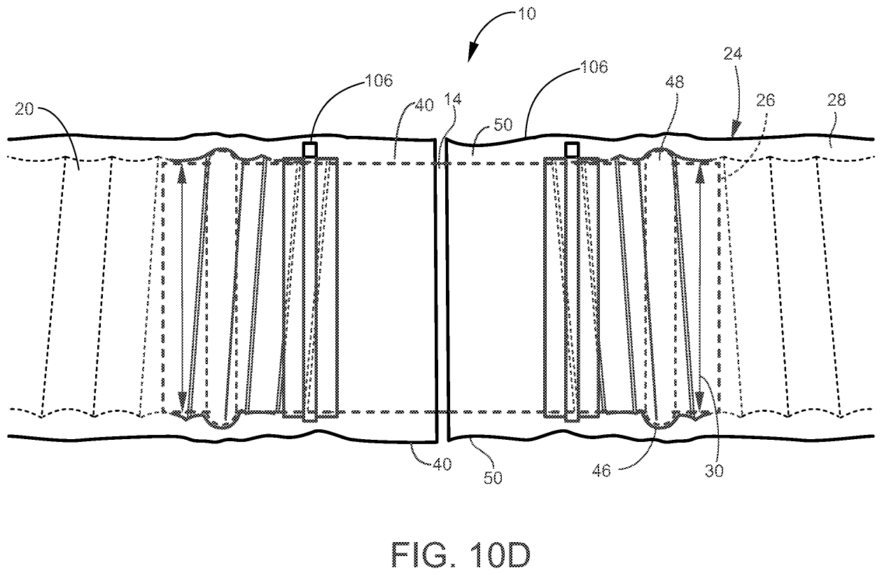

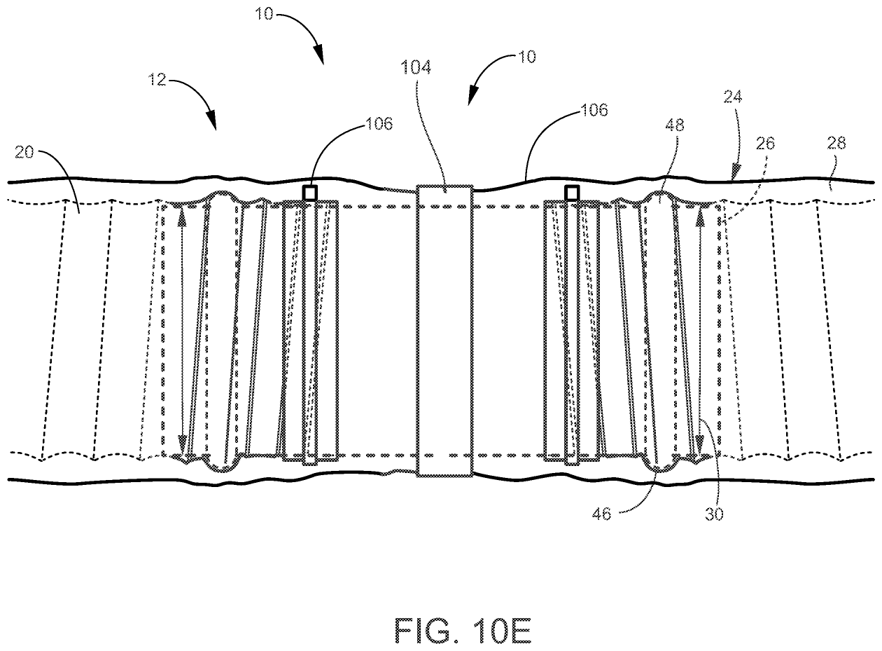

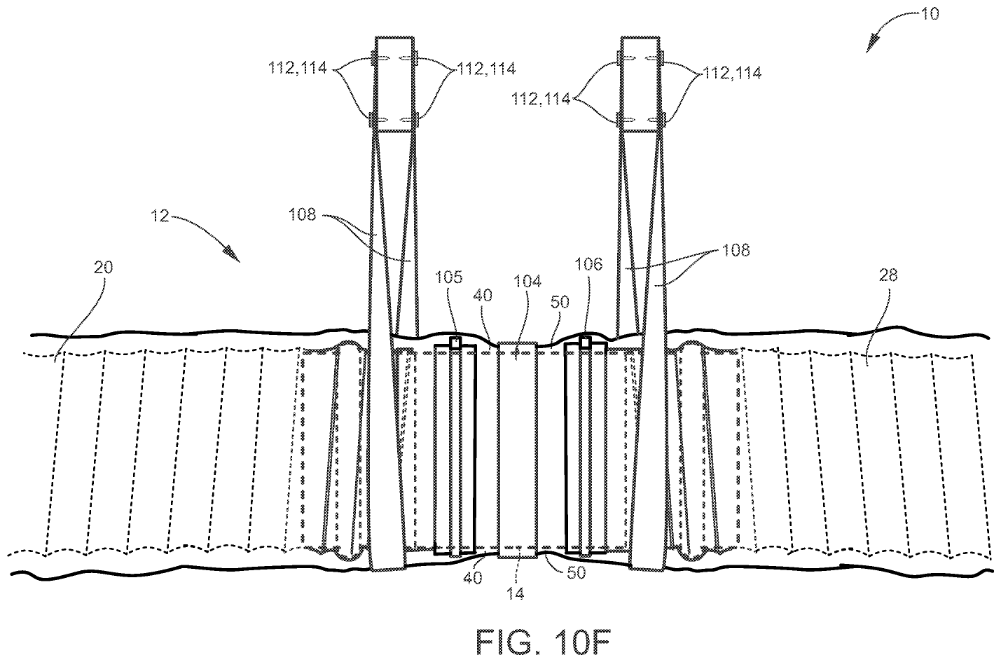

As shown in FIGS. 1-7 and 10, in select embodiments of custom connector kit 10 for connecting two flexible ducts together 12, connector device 14 may further include first taping surface 32 with first rounded lip 38 and second taping surface 42 with second rounded lip 48. First rounded lip 38 may be around first male connection end 16 at first lip distance 34 from first distal end 18. First rounded lip 38 may be configured for securing first inner liner 36 of first flexible duct 20 to first male connection end 16 (see FIGS. 10A-10F). First taping surface 32 may be provided around connector device 14. First taping surface 32 may be configured for taping first inner liner 36 of first flexible duct 20 to first male connection end 16. First taping surface 32 may be adjacent to first rounded lip 38. Second rounded lip 48 may be around second male connection end 24 at second lip distance 44 from second distal end 26 of connector device 14. Second rounded lip 48 may be configured for securing second inner liner 46 of second flexible duct 28 to second male connection end 24. Second taping surface 42 may be provided around connector device 14. Second taping surface 42 may be configured for taping second inner liner 46 of second flexible duct 28 to second male connection end 24. Second taping surface 42 may be adjacent to second rounded lip 48.

Referring to FIGS. 10A-10F, one feature of custom connector kit 10 for connecting two flexible ducts 12 together may be that connector device 14 may be configured for connecting first flexible duct 20 to second flexible duct 28 by: taping first inner liner 36 of first flexible duct 20 to first taping surface 32 at first male connection end 16, like via foil tape 104 (see FIG. 10A); securing first inner liner 36 of first flexible duct 20 to first male connection end 16, like via cable ties 106 (see FIG. 10B); taping second inner liner 46 of second flexible duct 28 to second taping surface 42 at second male connection end 24, like via foil tape 104 (see FIG. 10C); securing second inner liner 46 of second flexible duct 28 to second male connection end 24, like via cable ties 106 (see FIG. 10D); and taping first outer insulation 40 of first flexible duct 20 to second outer insulation 50 of second flexible duct 28 (see FIG. 10E). As shown in FIG. 10F, hanging straps 108 and roofing nails 112 and/or self-tapping metal screws 114 may be utilized for supporting or hanging connection device 14 between first flexible duct 20 and second flexible duct 28.

As best shown in FIGS. 1-6, another feature of custom connector kit 10 for connecting two flexible ducts 12 together may be that connector device 14 may include adjustable diameter 52. With adjustable diameter 52 of connector device 14, custom connector kit 10 may be configured with the ability to custom fit multiple size ducts together, including but not limited to, ducts sized between 6 and 16 inches. In select embodiments, connector device 14 with adjustable diameter 52 may include sheet of material 54 with rounded length 56 and width 58. Sheet of material 54 may any type, thickness, and/or size of material, including, but not limited to, galvanized metal material. Sheet of material 54 may be configured to bend along rounded length 56 to create circular pipe shape 60 of connector device 14 with adjustable diameter 52. In select embodiments, sheet of material 54 may include plurality of first holes 62 approximate fixed end 64 of rounded length 56. First set 66 of a plurality of second holes 68 may be approximate adjustable end 70 of rounded length 56. In addition, at least one second set 72 of a plurality of the second holes 68 may be included at set distance 74 from adjustable end 70 of rounded length 56. Wherein, adjustable diameter 52 of connector device 14 may be created by sheet of material 54 being adjustable between large diameter 76 and at least one smaller diameter 78. Large diameter 76 may be created by connecting first holes 62 at fixed end 64 of rounded length 56 with first set 66 of second holes 68 at adjustable end 70 of rounded length 56, like via screws 110, as shown in FIGS. 1, 3, 4 and 6. The at least one smaller diameter 78 may be created by connecting first holes 62 at fixed end 64 of rounded length 56 with one of the at least one second set 72 of second holes 68 at set distance 74 from adjustable end 70 of rounded length 56, like via screws 110.

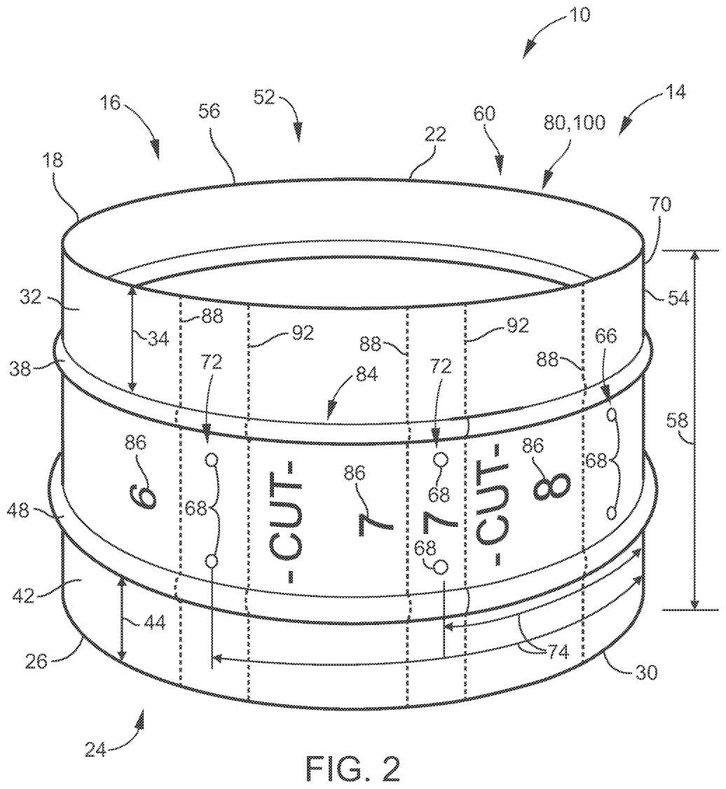

Referring now specifically to FIGS. 1-2, in select embodiments of custom connector kit 10 for connecting two flexible ducts 12 together, and clearly not limited thereto, adjustable diameter 52 of connector device 14 may be configured to adjust for connecting sizes of 6 inches through 8 inches of flexible ducts 12. This 6 inches through 8 inches embodiment of connector device 14 may include being configured for connecting 6-inch flexible ducts, 7-inch flexible ducts, and 8-inch flexible ducts 12.

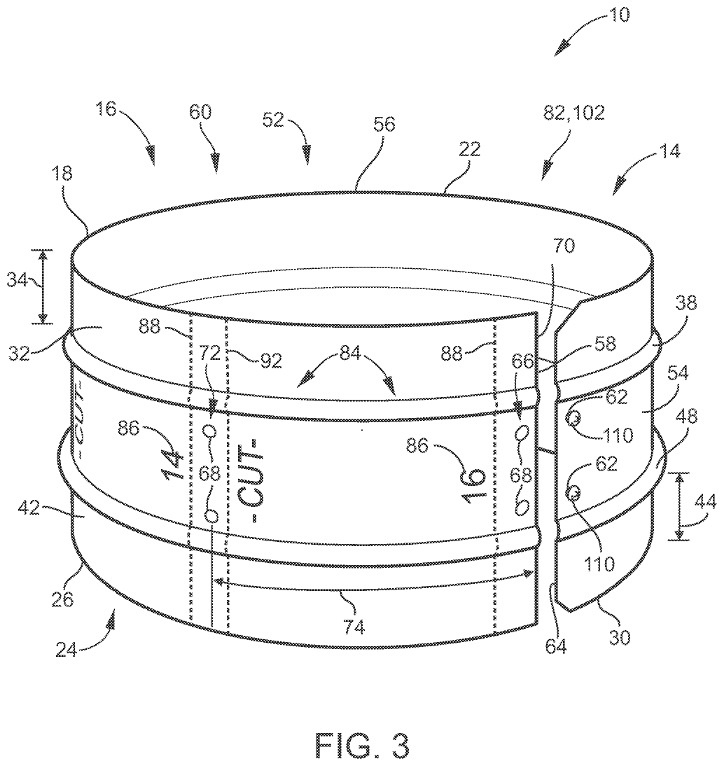

Referring now specifically to FIGS. 3-6, in select embodiments of custom connector kit 10 for connecting two flexible ducts 12 together, and clearly not limited thereto, adjustable diameter 52 of connector device may be configured to adjust for connecting sizes of 10 inches through 16 inches of flexible ducts. This 10 inches through 16 inches embodiment of connector device 14 may include being configured for connecting 10-inch flexible ducts, 12-inch flexible ducts, 14-inch flexible ducts, and 16-inch flexible ducts.

As shown in FIGS. 1-7, in select possibly preferred embodiments of custom connector kit 10 for connecting two flexible ducts 12 together, at least two connector devices 14 may be included. First connector device 80 may be included wherein adjustable diameter 52 of connector device 14 may be configured to adjust for connecting sizes of 6 inches through 8 inches of flexible ducts, including 6-inch flexible ducts, 7-inch flexible ducts, and 8-inch flexible ducts. Second connector device 82 may be included wherein adjustable diameter 52 of connector device 14 may be configured to adjust for connecting sizes of 10 inches through 16 inches of flexible ducts, including 10-inch flexible ducts, 12-inch flexible ducts, 14-inch flexible ducts, and 16-inch flexible ducts.

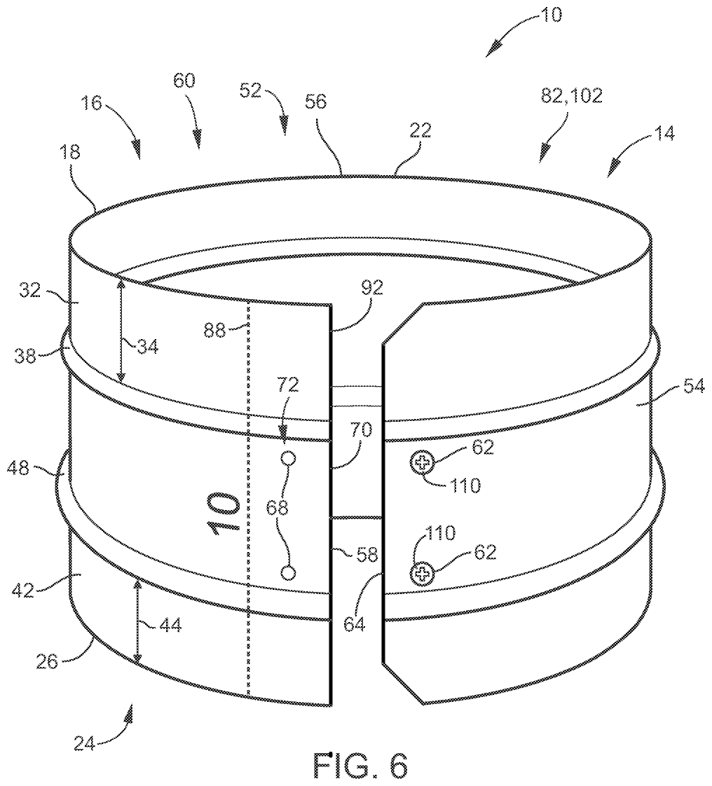

Still referring to FIGS. 1-6, another feature of custom connector kit 10 for connecting two flexible ducts 12 together may be that sheet of material 54 used for creating connector device 14 can further including markings 84. Markings 84 may include markings or indications for first set 66 of second holes 68 and each of the second sets 72 of the second holes 68. In select embodiments, markings 84 for first set 66 of second holes 68 may include number 86 and diameter line 88. Number 86 may indicate adjustable diameter 52 of connector device 14 at the corresponding first set 66 of second holes 68. Diameter line 88 may indicate fixed end location 90 for creating a corresponding adjustable diameter 52. In other select embodiments, markings 84 for each of the second sets 72 of second holes 68 can include number 86, diameter line 88, and cut line 92. Number 86 may indicate adjustable diameter 52 of connector device 14 at the corresponding second set 72 of second holes 68. Diameter line 88 may indicate fixed end location 90 for creating a corresponding adjustable diameter 52. Cut line 92 may indicate a cutting location 94 for cutting excess material 96 of sheet of material 54 at the corresponding second set 72 of second holes 68. As shown in FIG. 6, the excess material 96 from making the adjustable diameter to 10 inches has been removed and the first holes 62 are ready to be connected to the second holes 68 to create adjustable diameter of 10 inches. In select embodiments of custom connector kit 10 for connecting two flexible ducts 12 together, custom connector kit 10 may include at least two connector devices 14. First connector device 80 may be included wherein adjustable diameter 52 of connector device 14 may be configured to adjust for connecting sizes of 6 inches through 8 inches of flexible ducts 12, including: 6-inch flexible ducts 12 where markings 84 may include number 86 being a number 6, diameter line 88 indicating fixed end location 90 for creating a 6-inch diameter, and cut line 92 for removing excess material 96 of the sheet of material 54 not required for the 6-inch diameter; 7-inch flexible ducts 12 where markings 84 may include number 86 being a number 7, diameter line 88 indicating fixed end location 90 for creating a 7-inch diameter, and cut line 92 for removing excess material 96 of sheet of material 54 not required for the 7-inch diameter; and 8-inch flexible ducts 12 where markings 84 may include number 86 being a number 8, and diameter line 88 indicating fixed end location 90 for creating an 8-inch diameter. Second connector device 82 may be included wherein adjustable diameter 52 of connector device 14 may be configured to adjust for connecting sizes of 10 inches through 16 inches of flexible ducts 12, including: 10-inch flexible ducts 12 where markings 84 can include number 86 being a number 10, diameter line 88 indicating fixed end location 90 for creating a 10-inch diameter, and cut line 92 for removing excess material 96 of sheet of material 54 not required for the 10-inch diameter; 12-inch flexible ducts 12 where markings 84 can include number 86 being a number 12, diameter line 88 indicating fixed end location 90 for creating a 12-inch diameter, and cut line 92 for removing excess material 96 of sheet of material 54 not required for the 12-inch diameter; 14-inch flexible ducts 12 where markings 84 can include number 86 being a number 14, diameter line 88 indicating fixed end location 90 for creating a 14-inch diameter, and cut line 92 for removing excess material 96 of sheet of material 54 not required for the 14-inch diameter; and 16-inch flexible ducts 12 where markings 84 may include number 86 being a number 16, and diameter line 88 indicating fixed end location 90 for creating a 16-inch diameter.

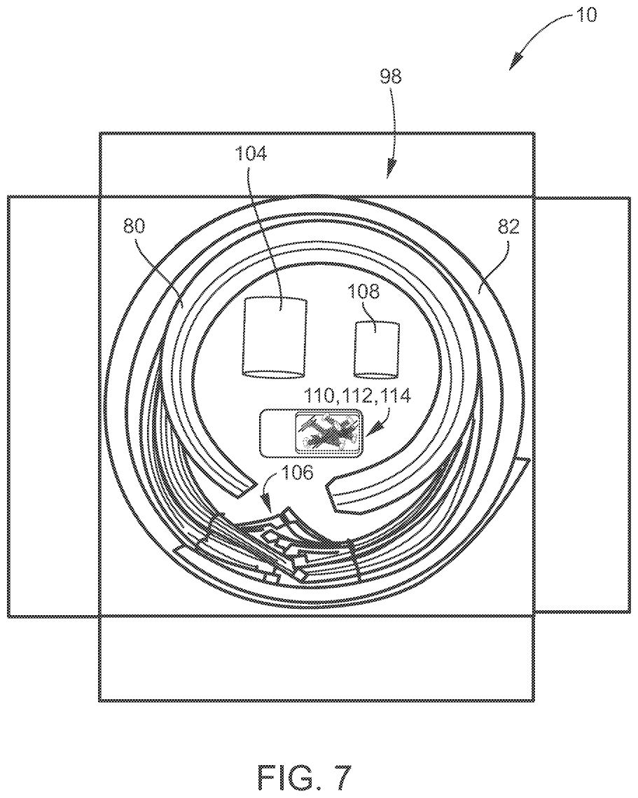

Referring now specifically to FIG. 7, one feature of custom connector kit 10 for connecting two flexible ducts 12 together may be that custom connector kit 10 can be configured with an ability to save space because it is knocked down or not put together.

Referring now specifically to FIGS. 7-9, another feature of custom connector kit 10 for connecting two flexible ducts 12 together may be that it can include necessary materials 98 to custom fit multiple size ducts 12 together. In select embodiments, necessary materials 98 may include, but are not limited to, small galvanized pipe connector 100 configured to fit sizes 6 inch through 8 inch; large galvanized pipe connector 102 configured to fit sizes 10 inch through 16 inch; fifteen feet of foil tape 104; twelve 36-inch cable ties 106; ten feet of nylon hanging strap 108; four 10×½ screws 110; one 12×12×6 box 111; four 1-inch roofing nails 112; four 5/12″×¾″ self-tapping metal screws 114; the like; and/or combinations thereof.

Referring now to FIGS. 1-7 and 10, in another aspect, the instant disclosure embraces connector device 14 for connecting two flexible ducts 12 together. Connector device 14 may include connector device 14 for custom connector kit 10 in any embodiment and/or embodiments of custom connector kit 10 and/or connector device 14 shown and/or described herein.

Referring now to FIG. 11, in another aspect, the instant disclosure embraces method 200 for connecting two flexible ducts 12 together. Method 200 for connecting two flexible ducts together may utilize the disclosed custom connector kit 10 and/or connector device 14 in any embodiment and/or embodiments shown and/or described herein. As such, in general method 200 for connecting two flexible ducts 12 together may include step 202 of providing connector device 14 configured to connect two flexible ducts 12 in any embodiment and/or embodiments shown and/or described herein. With the provided connector device 14, method 200 for connecting two flexible ducts 12 together may further include step 204 of connecting two flexible ducts 12 together via the provided connector device 14.

In select embodiments of method 200 for connecting two flexible ducts 12 together, method 200 may further include: step 206 of taping first inner liner 36 of first flexible duct 20 to first taping surface 32 at first male connection end 16 with foil tape 104 (see FIG. 10A); step 208 of securing first inner liner 36 of first flexible duct 20 to first male connection end 16 with cable ties 106 (see FIG. 10B); step 210 of taping second inner liner 46 of second flexible duct 28 to second taping surface 42 at second male connection end 24 with foil tape 104 (see FIG. 10C); step 212 of securing second inner liner 46 of second flexible duct 28 to second male connection end 24 with cable ties 106 (see FIG. 10D); and step 214 of taping first outer insulation 40 of first flexible duct 20 to second outer insulation 50 of second flexible duct 28 with foil tape 104 (see FIG. 10E). In select embodiments, method 200 for connecting two flexible ducts 12 together may further include step 216 of supporting or hanging connector device 14 connected between first flexible duct 20 and second flexible duct 28 via hanging strap or straps 108 and the provided roofing nails 112 and/or self-tapping metal screws 114 (see FIG. 10F).

In sum, the disclosed custom connector kit 10 with connector device 14 for connecting together two flexible ducts may be designed and provided with an ability to custom fit multiple size ducts 12 together. The disclosed custom connector kit 10 may have the ability to save space because it is knocked down (not put together) when shipped and/or taken to a job site.

### EXAMPLE

An example custom connector kit 10 may include the following components: small galvanized pipe connector 100 configured to fit sizes 6 inch through 8 inch; large galvanized pipe connector 102 configured to fit sizes 10 inch through 16 inch; 15′ of foil tape 104; 12-36″ cable ties (Panduit straps) 106; 10 feet of nylon hanging strap 108; 4-10×½ Phillips head screws 110; 1-12×12×6 box 111; 4-1″ roofing nails 112; and 4- 5/12″×¾″ self-tapping metal screws 114.

In use, the tools needed may include a steak knife or utility knife or scissors, wire cutters and a Phillips head screwdriver. Applicant notes that extreme caution should be used when handling sheet metal connectors. Using the knife or scissors, the flex duct outer insulation around the duct and tuck the outer insulation to reveal the damaged plastic inner liner. Using the knife or scissors, cut the plastic inner liner around the duct. Using a pair of wire cutters, cut the plastic inner liner spiral wire of the flex duct. Using the same procedure, remove the damaged flex duct and discard. Measure the plastic inner liner diameter. This is the dimension to use in selecting the adjustable diameter 52 of connector device 14 from custom connector kit 10. Select small galvanized pipe connector 100 configured to fit sizes 6 inch through 8 inch, or large galvanized pipe connector 102 configured to fit sizes 10 inch through 16 inch. Line up fixed end 64 (with the notched corners) with he selected size of the inner liner diameter and secure with the Phillips head screws 110 provided. If preferred, and you have a pair of sheet metal snips, optionally you can remove excess material 96 from the sheet of material 54 not being used for smaller diameters 78.

Take one end of flex duct 12 and slide it over first male connection end 16 of connector device 14 just past first rounded lip 38 and onto first taping surface 32. With foil tape 104, tape the plastic inner liner to first taping surface 32 so that foil tape 104 is equal distance on the plastic inner liner and first taping surface 32 of connector device 14. With the cable ties 106 (like Panduit straps) provided, secure the cable ties 106 around the plastic inner liner on first taping surface 32 and pull the cable tie 106 as tight as possible to insure a tight connection. Remove the excess of cable tie 106 with wire cutters.

Take the other end of flex duct 12 and slide it over second male connection end 24 of connector device 14 just past second rounded lip 48 and onto second taping surface 42. With foil tape 104, tape the plastic inner liner to second taping surface 42 so that foil tape 104 is equal distance on the plastic inner liner and second taping surface 42 of connector device 14. With the cable ties 106 (like Panduit straps) provided, secure the cable ties 106 around the plastic inner liner on second taping surface 42 and pull the cable tie 106 as tight as possible to insure a tight connection. Remove the excess of cable tie 106 with wire cutters.

Untuck the outer insulation from each flex duct 12 and pull to cover all of connector device 14 and overlap with one another. With foil tape 104, tape the outer insulation layers from each flex duct 12 together.

With nylon hanging strap 108 provided, support or hang connector device 14 connected between the two flex ducts 12 underneath connector device 14. And with roofing nails 112 provided nail the nylon hanging strap to wood or with self-tapping metal screws 114 provided, screw the nylon hanging strap 108 to the metal of the structure.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A custom connector kit for connecting two flexible ducts together, the custom connector kit comprising:
a connector device configured to connect the two flexible ducts together, the connector device including:
a first male connection end at a first distal end of the connector device, the first male connection end is configured to be connected to a first flexible duct, the first male connection end including a first diameter sized to fit securely inside of the first flexible duct; and
a second male connection end at a second distal end of the connector device, the second male connection end is configured to be connected to a second flexible duct, the second male connection end including a second diameter sized to fit securely inside of the second flexible duct.

2. The custom connector kit for connecting two flexible ducts together of claim 1, wherein the connector device further including:
a first rounded lip around the first male connection end at a first lip distance from the first distal end of the connector device, the first rounded lip is configured for securing a first inner liner of the first flexible duct to the first male connection end;
a first taping surface around the connector device, the first taping surface is configured for taping the first inner liner of the first flexible duct to the first male connection end, the first taping surface is adjacent to the first rounded lip;
a second rounded lip around the second male connection end at a second lip distance from the second distal end of the connector device, the second rounded lip is configured for securing a second inner liner of the second flexible duct to the second male connection end; and
a second taping surface around the connector device, the second taping surface is configured for taping the second inner liner of the second flexible duct to the second male connection end, the second taping surface is adjacent to the second rounded lip.

3. The custom connector kit for connecting two flexible ducts together of claim 2, whereby the connector device may be configured for connecting the first flexible duct to the second flexible duct by:
taping the first inner liner of the first flexible duct to the first taping surface at the first male connection end;
securing the first inner liner of the first flexible duct to the first male connection end;
taping the second inner liner of the second flexible duct to the second taping surface at the second male connection end;
securing the second inner liner of the second flexible duct to the second male connection end; and
taping a first outer insulation of the first flexible duct to a second outer insulation of the second flexible duct.

4. The custom connector kit for connecting two flexible ducts together of claim 1, wherein the connector device including an adjustable diameter, wherein the custom connector kit is configured with an ability to custom fit multiple size ducts together.

5. The custom connector kit for connecting two flexible ducts together of claim 4, wherein the connector device with an adjustable diameter including:
a sheet of material with a rounded length and a width, the sheet of material is configured to bend along the rounded length to create a circular pipe shape of the connector device with the adjustable diameter.

6. The custom connector kit for connecting two flexible ducts together of claim 5, wherein the sheet of material including:
a plurality of first holes approximate a fixed end of the rounded length;
a first set of a plurality of second holes approximate an adjustable end of the rounded length; and
at least one second set of the plurality of the second holes at a set distance from the adjustable end of the rounded length;
wherein, the adjustable diameter of the connector device created by the sheet of material is adjustable between:
a large diameter created by connecting the plurality of the first holes at the fixed end of the rounded length with the first set of the plurality of the second holes at the adjustable end of the rounded length; and
at least one smaller diameter created by connecting the plurality of the first holes at the fixed end of the rounded length with one of the at least one second set of the plurality of the second holes at the set distance from the adjustable end of the rounded length.

7. The custom connector kit for connecting two flexible ducts together of claim 6, wherein the adjustable diameter of the connector device is configured to adjust for connecting sizes of 6 inches through 8 inches of flexible ducts, including 6-inch flexible ducts, 7-inch flexible ducts, and 8-inch flexible ducts.

8. The custom connector kit for connecting two flexible ducts together of claim 6, wherein the adjustable diameter of the connector device is configured to adjust for connecting sizes of 10 inches through 16 inches of flexible ducts, including 10-inch flexible ducts, 12-inch flexible ducts, 14-inch flexible ducts, and 16-inch flexible ducts.

9. The custom connector kit for connecting two flexible ducts together of claim 6 including at least two connector devices including:
a first connector device wherein the adjustable diameter of the connector device is configured to adjust for connecting sizes of 6 inches through 8 inches of flexible ducts, including 6-inch flexible ducts, 7-inch flexible ducts, and 8-inch flexible ducts; and
a second connector device wherein the adjustable diameter of the connector device is configured to adjust for connecting sizes of 10 inches through 16 inches of flexible ducts, including 10-inch flexible ducts, 12-inch flexible ducts, 14-inch flexible ducts, and 16-inch flexible ducts.

10. The custom connector kit for connecting two flexible ducts together of claim 6, wherein the sheet of material further including markings for the first set of the plurality of the second holes and each of the second set of the plurality of the second holes.

11. The custom connector kit for connecting two flexible ducts together of claim 10, wherein:
the markings for the first set of the plurality of the second holes including:
a number indicating the adjustable diameter of the connector device at the corresponding first set of the plurality of the second holes; and
a diameter line indicating a fixed end location for creating the corresponding adjustable diameter; and
the markings for each of the second sets of the plurality of the second holes including:
the number indicating the adjustable diameter of the connector device at the corresponding second set of the plurality of the second holes;
the diameter line indicating a fixed end location for creating the corresponding adjustable diameter; and
a cut line indicating a cutting location for cutting excess material of the sheet of material at the corresponding second set of the plurality of the second holes.

12. The custom connector kit for connecting two flexible ducts together of claim 11 including at least two connector devices including:
a first connector device wherein the adjustable diameter of the connector device is configured to adjust for connecting sizes of 6 inches through 8 inches of flexible ducts, including:
6-inch flexible ducts where the markings including the number being a number 6, a diameter line indicating the fixed end location for creating a 6-inch diameter, and the cut line for removing excess material of the sheet not required for the 6-inch diameter;
7-inch flexible ducts where the markings including the number being a number 7, a diameter line indicating the fixed end location for creating a 7-inch diameter, and the cut line for removing excess material of the sheet not required for the 7-inch diameter; and
8-inch flexible ducts where the markings including the number being a number 8, and a diameter line indicating the fixed end location for creating an 8-inch diameter; and
a second connector device wherein the adjustable diameter of the connector device is configured to adjust for connecting sizes of 10 inches through 16 inches of flexible ducts, including:
10-inch flexible ducts where the markings including the number being a number 10, a diameter line indicating the fixed end location for creating a 10-inch diameter, and the cut line for removing excess material of the sheet not required for the 10-inch diameter;
12-inch flexible ducts where the markings including the number being a number 12, a diameter line indicating the fixed end location for creating a 12-inch diameter, and the cut line for removing excess material of the sheet not required for the 12-inch diameter;
14-inch flexible ducts where the markings including the number being a number 14, a diameter line indicating the fixed end location for creating a 14-inch diameter, and the cut line for removing excess material of the sheet not required for the 14-inch diameter; and
16-inch flexible ducts where the markings including the number being a number 16, a diameter line indicating the fixed end location for creating a 16-inch diameter.

13. The custom connector kit for connecting two flexible ducts together of claim 1 wherein the custom connector kit is configured with an ability to save space because it is knocked down or not put together.

14. The custom connector kit for connecting two flexible ducts together of claim 1, wherein the custom connector kit includes necessary materials to custom fit multiple size ducts together.

15. The custom connector kit for connecting two flexible ducts together of claim 14, wherein the necessary materials comprising:
a small galvanized pipe connector configured to fit sizes 6 inch through 8 inch;
a large galvanized pipe connector configured to fit sizes 10 inch through 16 inch;
fifteen feet of foil tape;
twelve 36-inch cable ties;
ten feet of nylon hanging strap;
four 10×½ screws;
one 12×12×6 box;
four 1-inch roofing nails; and
four 5/12″×¾″ self-tapping metal screws.

16. A connector device for connecting two flexible ducts together, the connector device comprising:
a first male connection end at a first distal end of the connector device, the first male connection end is configured to be connected to a first flexible duct, the first male connection end including a first diameter sized to fit securely inside of the first flexible duct; and
a second male connection end at a second distal end of the connector device, the second male connection end is configured to be connected to a second flexible duct, the second male connection end including a second diameter sized to fit securely inside of the second flexible duct.

17. The connector device for connecting two flexible ducts together of claim 16, wherein the connector device further including:
a first rounded lip around the first male connection end at a first lip distance from the first distal end of the connector device, the first rounded lip is configured for securing a first inner liner of the first flexible duct to the first male connection end;
a first taping surface around the connector device, the first taping surface is configured for taping the first inner liner of the first flexible duct to the first male connection end, the first taping surface is adjacent to the first rounded lip;
a second rounded lip around the second male connection end at a second lip distance from the second distal end of the connector device, the second rounded lip is configured for securing a second inner liner of the second flexible duct to the second male connection end; and
a second taping surface around the connector device, the second taping surface is configured for taping the second inner liner of the second flexible duct to the second male connection end, the second taping surface is adjacent to the second rounded lip.

18. The connector device for connecting two flexible ducts together of claim 17 including an adjustable diameter, wherein the connector device is configured with the ability to custom fit multiple size ducts together, wherein the connector device with an adjustable diameter including:
a sheet of material with a rounded length and a width, the sheet of material is configured to bend along the rounded length to create a circular pipe shape of the connector device with the adjustable diameter, wherein the sheet of material including:
a plurality of first holes approximate a fixed end of the rounded length;
a first set of a plurality of second holes approximate an adjustable end of the rounded length; and
at least one second set of a plurality of the second holes at a set distance from the adjustable end of the rounded length;
wherein, the adjustable diameter of the connector device created by the sheet of material is adjustable between:
a large diameter created by connecting the plurality of the first holes at the fixed end of the rounded length with the first set of the plurality of the second holes at the adjustable end of the rounded length; and
at least one smaller diameter created by connecting the plurality of the first holes at the fixed end of the rounded length with one of the at least one second set of the plurality of the second holes at the set distance from the adjustable end of the rounded length;
wherein:
the adjustable diameter of the connector device is configured to adjust for connecting sizes of 6 inches through 8 inches of flexible ducts, including 6-inch flexible ducts, 7-inch flexible ducts, and 8-inch flexible ducts; or
the adjustable diameter of the connector device is configured to adjust for connecting sizes of 10 inches through 16 inches of flexible ducts, including 10-inch flexible ducts, 12-inch flexible ducts, 14-inch flexible ducts, and 16-inch flexible ducts;
wherein the sheet of material further including markings for the first set of the plurality of the second holes and each of the second sets of the plurality of the second holes, wherein:
the markings for the first set of the plurality of the second holes including:
a number indicating the adjustable diameter of the connector device at the first set of the plurality of the second holes;
a diameter line indicating a fixed end location for creating a corresponding adjustable diameter; and
the markings for each of the second sets of the plurality of the second holes including:
the number indicating the adjustable diameter of the connector device at the corresponding second set of the plurality of the second holes;
the diameter line indicating a fixed end location for creating a corresponding adjustable diameter; and
a cut line indicating a cutting location for cutting excess material of the sheet of material at the corresponding second set of the plurality of the second holes.

19. A method for connecting two flexible ducts together, wherein the method comprising:
providing a connector device configured to connect the two flexible ducts together, the connector device including:
a first male connection end at a first distal end of the connector device, the first male connection end is configured to be connected to a first flexible duct, the first male connection end including a first diameter sized to fit securely inside of the first flexible duct; and
a second male connection end at a second distal end of the connector device, the second male connection end is configured to be connected to a second flexible duct, the second male connection end including a second diameter sized to fit securely inside of the second flexible duct; and
connecting the two flexible ducts together via the provided connector device.

20. The method for connecting the two flexible ducts together of claim 19, wherein the connector device further including:
a first rounded lip around the first male connection end at a first lip distance from the first distal end of the connector device, the first rounded lip is configured for securing a first inner liner of the first flexible duct to the first male connection end;
a first taping surface around the connector device, the first taping surface is configured for taping the first inner liner of the first flexible duct to the first male connection end, the first taping surface is adjacent to the first rounded lip;
a second rounded lip around the second male connection end at a second lip distance from the second distal end of the connector device, the second rounded lip is configured for securing a second inner liner of the second flexible duct to the second male connection end;
a second taping surface around the connector device, the second taping surface is configured for taping the second inner liner of the second flexible duct to the second male connection end, the second taping surface is adjacent to the second rounded lip;
wherein, the method for connecting the two flexible ducts together further including:
taping the first inner liner of the first flexible duct to the first taping surface at the first male connection end with foil tape;
securing the first inner liner of the first flexible duct to the first male connection end with cable ties;
taping the second inner liner of the second flexible duct to the second taping surface at the second male connection end with the foil tape;
securing the second inner liner of the second flexible duct to the second male connection end with the cable ties; and
taping a first outer insulation of the first flexible duct to a second outer insulation of the second flexible duct with the foil tape.
